(19) United States
(12) Patent Application Publication
(10) Pub. No.: US 2007/0132576 A1
(43) Pub. Date: Jun. 14, 2007

(54) Method and apparatus for tracking persons

(75) Inventors: Soumitri N. Kolavennu, Minneapolis, MN (US); Anoop K. Mathur, Shoreview, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/297,089

(22) Filed: Dec. 8, 2005

(51) Int. Cl. G08B 1/08

(52) U.S. Cl. 340/539.13; 340/539.12

(57) ABSTRACT

In accordance with the principles of the invention, one or more individuals carry a wireless beaconing device that transmits a signal on a regular basis, such as every five seconds, that can be detected by a plurality of wireless receivers positioned at various locations in a household or other area. The receivers form nodes of a wireless network that further includes a control node. Each wireless receiver records the signal strength at which it receives the signal from the beaconing device and sends that information to the control node. The control node correlates this information and uses it to estimate the location of the individual. In this manner, the controller can track the location and movement of a person and provide that information to a caregiver or further process the data to analyze it for particular traits that might indicate that an individual is injured or otherwise in need of assistance. Such traits might include a lack of movement for an extended period of time, failure to go to a particular place in the household, such as the bathroom, on a reasonably regular basis, etc.

### FIELD OF THE INVENTION

The invention pertains to the tracking of individuals. More specifically, the invention is particularly adapted for the care and monitoring of persons having medical or other conditions that might prevent them from being able to perform everyday functions.

### BACKGROUND OF THE INVENTION

There are circumstances under which it may be necessary or advisable to track the movements of one or more persons within a relatively well-defined space, such as a home, hospital, or prison. For instance, elderly or infirm persons that live alone or in a nursing home may need frequent or even relatively constant monitoring by caregivers. In order to reduce the staffing needs for monitoring and caring for persons in such situations and/or to reduce the burden on other family members or household members, it would be desirable to automate to the extent possible the monitoring of such persons.

For instance, in many instances it may be desirable to monitor the movement of a person about a house so as to know if that person is going to the bathroom or using the kitchen on a normal basis. Alternately, it may be desirable to track the movement of a person in order to assure that the person is moving on a regular basis and not incapacitated or otherwise unable to move.

In other situations, for instance, institutional situations such as nursing homes or hospitals, it may simply be advantageous to know the whereabouts of individuals so that they can be located for purposes of being provided medications or other care or simply to find them when they are missing.

Accordingly, it is an object of the present invention to provide an improved method for tracking individuals.

It is another object of the present invention to provide an improved apparatus for tracking individuals.

It is a further object of the present invention to provide a new method and apparatus for determining the location of a beaconing device relative to a plurality of signal receiving devices that receive a signal from the beaconing device.

### SUMMARY OF THE INVENTION

In accordance with the principles of the present invention, one or more individuals carries a small, lightweight wireless beaconing device that sends out a low-power radio signal that can be detected by a plurality of wireless receivers positioned at various locations in a household (or other space). The beaconing device may be contained within an article easily worn on the person's body, such as a piece of jewelry, a watch, or a key fob. In a preferred embodiment of the invention, the signal transmitted by each wireless beaconing device comprises an ID that uniquely identifies the beaconing device, and, therefore, the individual carrying it. However, in environments in which there is only one individual carrying such a beaconing device, the unique ID may be omitted from the transmit signal. In a preferred embodiment of the invention, the receivers form nodes of a wireless network that further includes a controller at a control node with which the receivers can communicate. Alternately, the controller may be incorporated directly within one of the receiver nodes (e.g., within one of the control panels of the system).

Each beaconing device transmits its signal at intervals, such as fixed intervals of every thirty seconds. Each wireless receiver that receives the signal from the beaconing device records the signal strength at which it receives the signal from the beaconing device, as well as the ID of the beaconing device, if so adapted, and sends that information to the control node. The control node correlates the information received from the multiple receivers and uses it to estimate the instantaneous location of the individual. Over time, the control node can determine the movements of the individual and evaluate that information to assess whether the individual requires attention from a caregiver.

In terms of determining the instantaneous location of an individual, in one embodiment to of the invention, the control algorithm may simply decide that the individual is in the room of the receiver that receives the strongest signal from the particular beaconing device. However, in other, more complex embodiments of the invention, the controller may perform an algorithm that more precisely estimates the position of the beaconing device by trilateration based on the signal strengths reported by multiple receivers or by triangulation based on differences in the time that each receiver receives the transmitted signal from the beaconing device.

In this manner, the controller can track the location and movement of a person and provide that information through an interface device, such as a computer monitor, to caregivers. In other embodiments, the controller can further process the data collected from the receivers and analyze it for particular traits that might indicate that the individual is injured or otherwise having difficulty. Such traits might include lack of movement for an extended period of time, failure to go to a particular place in the household, such as the bathroom, on a reasonably regular basis, or too frequent visits to a particular place in the household, such as the bathroom.

The present invention permits family members, organizations, and institutions to provide better care and monitoring of persons with fewer staff and, therefore, lower costs.

### BRIEF DESCRIPTION OF THE DRAWINGS

FIG. 1 is a block diagram illustrating the basic components of a tracking system incorporating the principles of the present invention.

FIG. 2 is a schematic plan view of a household incorporating a tracking system in accordance with the principles of the present invention.

FIG. 3 is a block diagram illustrating the components of one of the wireless beaconing devices of FIG. 1 in accordance with a particular embodiment of the present invention.

FIG. 4 is a block diagram illustrating the components of one of the wireless receivers of FIG. 1 in accordance with a particular embodiment of the present invention.

FIG. 5 is a block diagram illustrating the components of the controller of FIG. 1 in accordance with a particular embodiment of the present invention.

### DETAILED DESCRIPTION OF THE INVENTION

Home security systems are widely available in which a plurality of the detector devices, such as door and window monitors designed to detect the opening of a door or window (such as by the loss of electrical continuity between two electrodes in which one is mounted to the moveable window or door and the other is mounted to the frame of the window or door), and sound detectors (e.g., adapted to detect the sound of breaking glass) are coupled to one or more control panels from which the owner of the residence can control the security system. In addition, the system typically also includes an alarm node that will sound an alarm in the event of certain circumstances (e.g., a window being opened when the system is enabled). Often, the system is also hooked up to the telephone line so that it can make a telephone call to a security company when the alarm is activated. The detector nodes, control panel nodes, and alarm nodes essentially comprise a Local Area Network (LAN).

Typically, a security system for a household will have a control panel mounted near one or more of the primary entryways into the house and also in the master bedroom. A control panel commonly will comprise a keypad for entering data and an LED or LCD display for displaying information about the status of the security system. Typically, an individual enables or disables one or more portions of the security system by punching a security code into the keypad.

In many of these security systems, the various nodes are connected to each other through wires. However, recently, such security systems are wireless systems. That is, each node includes a radio frequency (RF) transmitter, receiver, or transceiver depending on the particular type of node and the nodes communicate with each other via low-power RF transmissions. Fro instance, the detector nodes for the doors and windows generally will only transmit. Control panel nodes generally will be both transmitters and receivers (i.e., transceivers). An alarm node may be a transceiver also, but could be only a receiver.

The Ademco™ technology developed by Honeywell International, Inc., is a radio chip set and a series of products that incorporate that chip set in conjunction with sensors is a wireless transceiver security system widely used throughout the United States and the world in wireless security systems such as those described above. The Ademco technology includes wireless control panels, wireless detectors, and even wireless remote transmitters that can be placed within key fobs, watches, jewelry, or other personal items for remotely enabling or disabling the security system. For instance, a person might press a button on the remote unit when he or she arrives home, which will then transmit a unique code to the control node of the system instructing the system to disarm.

All of these features of the Ademco system could be useful in a system for monitoring and tracking the movements of individuals about a household, institution, or any other space.

The present invention pertains to a method and apparatus for monitoring the location and movement of a person about a household or other space by having the person carry a wireless beaconing device that periodically transmits a beacon signal. FIG. 1 is a block diagram illustrating the basic components of a system 100 incorporating an embodiment of the present invention. In a preferred embodiment of the invention, the beaconing device 102 transmits a beaconing signal that includes (or solely comprises) a unique ID (although the unique ID would not be necessary if only one person is to be tracked in any given household). The household or other space is equipped with a plurality of wireless receivers 104 (hereinafter anchors or anchor devices) for receiving the signals transmitted by the beaconing device 102. The anchors 104 should remain stationary once installed. Each time the beaconing device 102 sends out a signal and it is received by one or more of the anchor devices 104, each anchor device records the ID of the beaconing device. The anchors also determine and record the received signal strength of the beaconing signal. The various IEEE 802.11 specifications provide an exemplary technique for measuring RSSI (Received Signal Strength Indicator) for a received radio signal. This technique would be one way to determine received signal strength. However, the received signal strength may be determined in any reasonable fashion.

Each anchor device that receives a beaconing signal sends the ID of the beaconing device and its signal strength information to a controller 106 at a control node of the wireless network 100. The anchor also should send a signal uniquely identifying the anchor unit that is transmitting the information so that the controller will know which anchor sent the information. The control node may comprise any reasonable computing device, such as a microprocessor, PC, ASIC, state machine, processor, combinational logic, and any combination of software and hardware. The controller 106 correlates the information from the various anchor nodes and calculates an estimate of the position of the beaconing device. This process is repeated every time the beaconing device 102 transmits its signal.

The controller 106 preferably is pre-programmed with the location of each anchor node within the space being monitored so that it can translate the information received from the anchor devices into a physical location.

The control node 106 maintains a continuous record of the estimated location of the person. From this record, the movement of the person over a period of time can be determined relatively accurately. In one embodiment of the invention, the controller 106 may simply store this information for later retrieval by a caregiver. The controller may provide this information to the caregiver in any reasonable form, such a list of the start and end time of the tracked person in each room or a map showing a trail of the movement of the tracked person with or without time stamps. This information can be used to determine whether the person is moving about in a normal or expected fashion. It can also be used to determine if a person is going places within the space that he or she should not be. Furthermore, it can be used to determine if a person is visiting the bathroom too few or too many times.

For instance, if a tracked person has not moved from a single position for an extended period of time (during a period of the day it when they should not be sleeping or otherwise stationary), this might indicate a problem. Alternately, if, over the course of a 24 hour period, it is determined that an individual has not been in a bathroom or visited a room containing that person's medication, this may indicate another problem.

In a preferred embodiment of the invention, a plurality of anchor nodes are positioned throughout the household. In one embodiment of the invention, one anchor node may be positioned in each room of the household. In other embodiments, particularly smaller households or systems using an algorithm that can accurately estimate the location of a beaconing device with fewer anchor nodes, there may not be a need for an anchor device in every room.

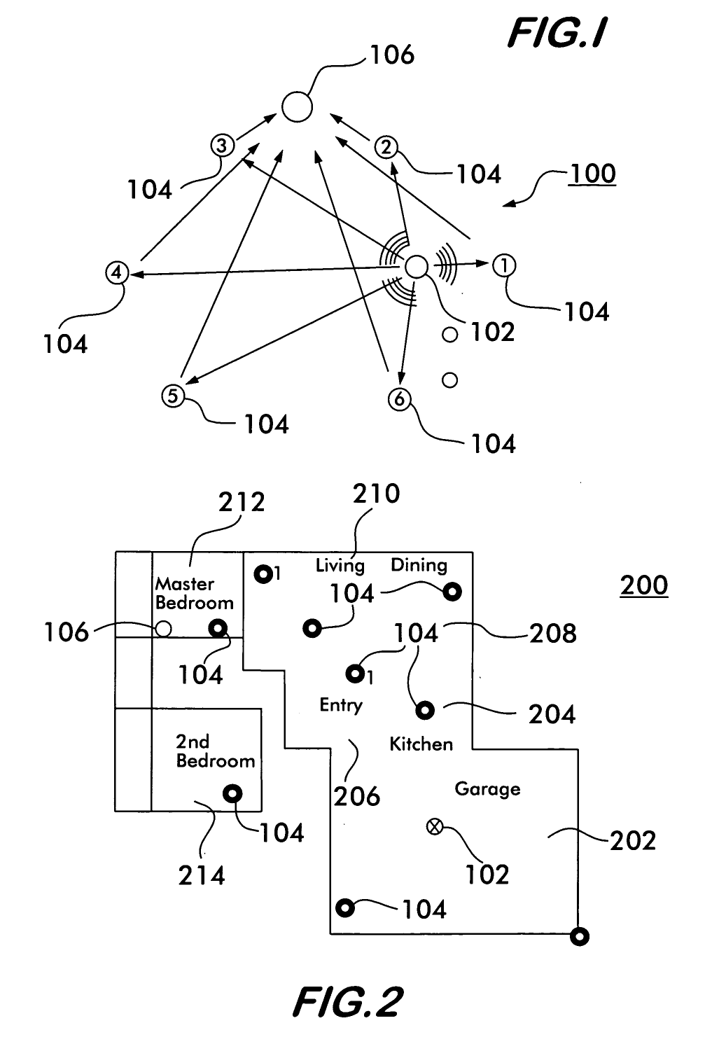

FIG. 2 is a block diagram illustrating a system in accordance with the principles of the present invention installed in a single level home. In this example, the home 200 comprises a garage 202, a kitchen 204, an entryway 206, a dining room 208, a living room 210, and two bedrooms, 212, and 214. Each room includes an anchor device 104. Anchor device 104 in master bedroom 212 also includes a controller 106. The system includes one or more wireless beaconing devices 102 carried on the person or persons to be monitored. Preferably, all communication between nodes of the network is wireless.

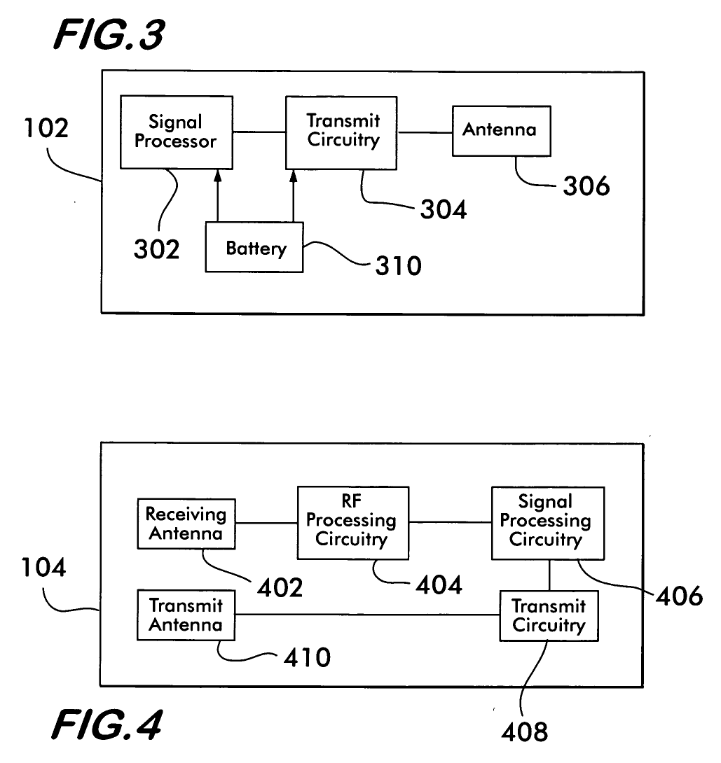

FIG. 3 is a block diagram illustrating the basic components of an exemplary beaconing devices 102. The beaconing device should contain minimal signal processing capabilities so that it can be made as small and light weight as possible whereby it can be easily worn or carried by the monitored individuals. The beaconing device contains signal processing circuitry 302 for generating the signal to be transmitted. It further comprises transmitter circuitry 304 for conditioning the signal for RF transmission. Merely as an example, the transmitter circuitry 304 typically might include circuitry for converting the signal from digital to analog form, circuitry for frequency up-converting the signal to RF, and other signal conditioning circuitry that would be well within the understanding of those of skill in these arts. The unit 102 further includes a transmission antenna 306. The signal processing circuitry 302 and transmitter circuitry 304 may be provided by one or more ASICs, microprocessors, analog hardware, digital hardware, or any other reasonable technology. The transmit circuitry outputs the transmit signal to an antenna 306 for transmission. The unit should be powered by a long-life, small, lightweight battery 310.

Preferably, each beaconing device transmits a binary signal that uniquely identifies that device. The system 200, of course, will be programmed to know what individual is carrying that particular device so as to be able to identify the individual from the particular ID.

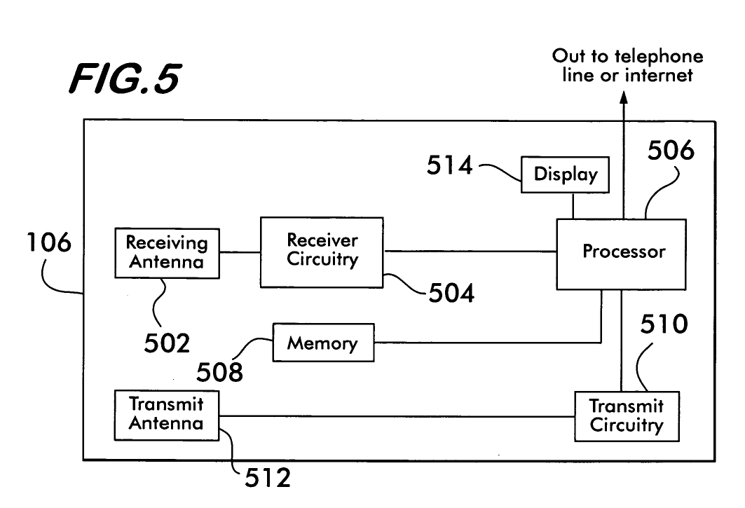

FIG. 4 is a block diagram illustrating the basic components of an exemplary anchor device 104. The anchor device includes a receiving antenna 402 and RF processing circuitry 404 coupled to the antenna for extracting the signal received from the beaconing devices. Circuitry 404 typically would include circuitry for frequency down converting the received RF signal to a baseband signal and converting it from analog to digital. Anchor device 104 further comprises signal processing circuitry 406 for at least determining the received signal strength. In a preferred embodiment, circuitry 406 also determines the particular ID received. The anchor device also includes transmit circuitry 408 and a transmit antenna 410 for transmitting the signal strength information and/or ID information to the control node. The receive and transmit antennas, of course, may be the same single antenna.

FIG. 5 is a block diagram of the basic components of the controller 106 of the system. It includes a receiving antenna 502. It also includes receiver circuitry 504 for extracting the signal strength and/or ID information received from the anchor nodes 104 and converting it to baseband digital signals. It further includes a processor 506 for analyzing the data received from the anchor nodes 104 in order to estimate the location of the one or more beaconing devices based on that information. It includes a memory 508 for storing that information over time so as to be able to construct the movement of the beaconing devices over time and process that data to create a log or map of the movement of the beaconing device(s) over time. As noted above, the controller is preferably also programmed or otherwise adapted to analyze the movement data and identify any unusual movements or lack thereof of individuals. Even further, the controller may be programmed or otherwise adapted to issue a special notification if it does detect any tracking information indicating unusual or unexpected behavior of the person being monitored. For instance, the controller may send an email or make a telephone call to a caretaker if it detects unusual behavior. Alternately, if the system is actively monitored by an individual, such as might be the case in an institution such as a nursing home or hospital, the controller may include a display device 514, such as a computer monitor, and might simply display a warning on the screen of the monitor when it detects unusual behavior.

Furthermore, although not particularly relevant to the principles of the present invention, the controller likely also includes transmit circuitry 510 and a transmit antenna 512 for sending signals and information to the anchor nodes. Particularly, the controller 106 will include programming for running the entire network. Such functionality typically would require that the controller not only be able to receive information from the anchor nodes, but also transmit information to them. For instance, the controller may periodically test anchor nodes to make sure they are operating properly. Also, it may occasionally the send new software to the anchoring nodes.

Various algorithms can be employed for estimating the location of the monitored individual based on the received signal strength. For instance, in one embodiment of the invention, the system can make a relatively broad determination of the instantaneous location of the person by simply deciding that the person is closest to the anchor device that reports the strongest signal strength. For example, if there is an anchor device in each room, then the person can be assumed to be in the room of the anchor device receiving the strongest signal. In many instances, this will be sufficient information for reasonably monitoring the individual.

However, if more precise estimation is desired, a more complex algorithm for estimating the location of the person can be employed. For instance, an algorithm can be used that considers the relative signal strengths recorded by multiple anchoring devices and triangulating the position on the person based on those relative signal strengths.

U.S. patent application Ser. No. ______ (attorney docket number H0011618-0760/Outside Counsel Docket No. P 31082 USA), entitled Method and Apparatus for Estimating the Location of a Signal Transmitter, incorporated herein fully by reference, discloses a novel technique for accurately estimating the location of a person based on the signal strengths of the transmit signal as received at multiple locations, such as multiple anchor devices.

In another embodiment of the invention, it may be possible to record the precise time of receipt of the signal at each anchor device and compare those times of receipt to each other to determine the differences between times of receipt and then trilaterate the position of the person based on that information. This technique would not use signal strength at all, but merely delay. In even further embodiments of the invention, an algorithm that uses both received signal strength and delay can be implemented.

As previously noted, the invention is particularly advantageous because it can be virtually entirely implemented with existing technology such as the control panels, controller, and remote transmitters (e.g., key fob) of a household security system. The control panels essentially can be used as the anchors with minimal reprogramming. Also, the remote transmitters can be used as the beaconing devices with minimal modifications. For instance, instead of requiring the pressing of a button in order to cause it to transmit a signal, the unit is programmed to transmit the signal at fixed intervals. Furthermore, the particular signal transmitted might need to be changed. Finally, the controller of the security system can be used as the controller of the tracking system. It would simply need new or additional software.

This is an important advantage of the present invention because the components of the tracking system can be designed quickly and inexpensively because they are comprised primarily of existing technology. However, even furthermore, a household security system and a tracking system in accordance with the principles of the present invention can be implemented with the same hardware. Thus, consumers that desire both types of systems in their homes (or other spaces) would be able to install one physical system that provides both functions at a reduced cost relative to purchasing and installing two different systems.

In a system such as disclosed hereinabove, the accuracy of the estimated position of the beaconing device depends on the accuracy to which the positions of the receivers are known. However, in the home care situation described above, the tracking system, and particularly the receivers of the tracking system will likely be installed by a lay person, such as a nurse or a relative of the person that is to be tracked. Accordingly, it is important that the process of installing the receivers be made as simple as possible. U.S. patent application Ser. No. ______ (attorney docket number H0011619-0760/ Outside Counsel Docket No. P 31054 USA), entitled Method and Apparatus for Installing and/or Determining the Position of a Receiver of a Tracking System, incorporated herein fully by reference, discloses a technique in which an installer carries a tracking device that can track the person's position and/or movements. The installer starts at a base location and resets the tracking device to cause the tracking device to record this position as the base position. The installer then walks to the location where the first receiving device will be installed while the tracking device tracks his or her movement or position. At the first installation location, the installer causes the tracking device to record this position as the position of the first receiver installed. The process is repeated for each receiver to be installed.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of determining the location of a person, said method comprising the steps of:
(1) said person carrying a wireless transmitting device adapted to transmit a signal at intervals;
(2) detecting said signal with a plurality of detectors positioned in different locations and determining the strength of said signal received at each of said plurality of detectors;
(3) estimating a position of said person based on said strengths of said received signal at said plurality of detectors;
(4) repeating steps (3) and (4) each time said wireless transmitting device transmits said signal; and
(5) tracking said person's movement by storing said estimates over a multiplicity of said intervals.

2. The method of claim 1 further comprising the step of:
(6) assessing said person's movement to detect particular behavioral patterns.

3. The method of claim 2 further comprising the step of:
(7) issuing a notification if, in step (6), a certain behavioral pattern is detected.

4. The method of claim 3 wherein step (7) comprises placing a telephone call.

5. The method of claim 1 wherein said signal comprises an ID uniquely identifying said wireless transmitting device.

6. The method of claim 1 wherein step (1) comprises a plurality of persons carrying a plurality of wireless transmitting devices and wherein said signal transmitted by each wireless transmitting device transmits an ID uniquely identifying said wireless transmitting device.

7. The method of claim 1 wherein step (3) comprises determining which of said detectors received said signal with the strongest signal strength and estimating that said person is in the vicinity of that detector.

8. The method of claim 1 wherein said method is practiced within a structure comprising a plurality of rooms and one of said detectors is positioned in each said room and wherein step (3) comprises estimating that said person is in said room corresponding to the one of said detectors that received said signal with the strongest signal strength.

9. The method of claim 1 wherein step (3) comprises trilaterating said estimated position based on said strength of said signal as received at said plurality of detectors.

10. The method of claim 1 further comprising the step of:
(8) wirelessly transmitting said signal strengths from said detectors to a controller; and
wherein said controller performs steps (3) and (5).

11. The method of claim 10 wherein said controller is pre-programmed with the locations of said detectors.

12. An apparatus for tracking the movement of a person comprising:
a beaconing device adapted to wirelessly transmit a signal at intervals;
a plurality of anchor devices each adapted to be positioned at various locations throughout a space to be monitored, said anchor devices further adapted to detect said signal transmitted by said beaconing device and determine a strength of said signal as received by the anchor device, said anchor devices further adapted to wirelessly transmit said signal strength;
a controller adapted to receive said signal strengths transmitted from said plurality of anchor devices and, based on said signal strengths, estimate a position of said beaconing device and further adapted to track movement of said beaconing device based on said estimates over a multiplicity of said signals transmitted by said beaconing device.

13. The apparatus of claim 12 wherein said anchor devices further comprise control panels of a security system and said controller further comprises the controller for said security system.

14. The apparatus of claim 12 wherein said controller is further adapted to assess said person's movement to detect particular behavioral patterns.

15. The apparatus of claim 14 wherein said controller is further adapted to issue a notification if a certain behavioral pattern is detected.

16. The apparatus of claim 15 wherein said controller is coupled to a telephone network and is adapted to place a telephone call to issue said notification.

17. The apparatus of claim 12 wherein said beaconing device comprises a plurality of beaconing devices and wherein said signal transmitted by each said beaconing device comprises a unique ID and wherein said anchor devices are further adapted to determine said unique ID from each said signal and to transmit it to said controller.

18. The apparatus of claim 12 wherein said controller determines which of said detectors received said signal with the strongest signal strength and estimating that said person is in the vicinity of that detector.

19. The apparatus of claim 12 wherein each of said anchor device is positioned in a separate room and wherein said controller is preprogrammed with information indicating which room each anchor is positioned in and wherein said controller estimates that said beaconing device is in said room corresponding to the one of said detectors that received said signal with the strongest signal strength.

20. The apparatus of claim 12 wherein said controller is preprogrammed with information indicating the position of each anchor and wherein said controller estimates the position of said beaconing device by trilaterating based on said strength of said signal as received at said plurality of detectors.
